(19) United States
(12) Patent Application Publication
(10) Pub. No.: US 2011/0119616 A1
(43) Pub. Date: May 19, 2011

(54) Displayable-Information Management System and Program

(75) Inventor: Hiroaki Suzuki, Nagoya-shi (JP)

(73) Assignee: BROTHER KOGYO KABUSHIKI KAISHA, Nagoya-shi (JP)

(21) Appl. No.: 13/010,210

(22) Filed: Jan. 20, 2011

Related U.S. Application Data
(63) Continuation-in-part of application No. PCT/JP2009/055590, filed on Mar. 23, 2009.

(30) Foreign Application Priority Data
Jul. 25, 2008 (JP) 2008-191671

(51) Int. Cl. G06F 3/01

(52) U.S. Cl. 715/772

(57) ABSTRACT

An information management system may include an information management apparatus and a display apparatus. The displayable-information management apparatus may include a storage unit that stores displayable information and read/unread status information and may be configured to determine read/unread status of the displayable information. The display apparatus may include a storage unit that stores the displayable information and read/unread status information acquired from the management apparatus and a display unit. In some arrangements, the display apparatus may determine whether displayable information has been read, and update the read/unread status information corresponding to the displayable information when the displayable information has been read. In some arrangements the read/unread status information might only be updated when the displayable-information management apparatus acquires the updated read/unread status information from the display apparatus and/or under certain predefined conditions.

### CROSS-REFERENCE TO RELATED APPLICATION

This application claims the benefit of priority from International Patent Application No. PCT/JP2009/055590, filed Mar. 3, 2009, which claims the benefit of priority from Japanese Patent Application No. 2008-191671, filed Jul. 25, 2008. The contents of the above referenced applications are incorporated herein by reference in their entirety.

### BACKGROUND

1. Technical Field

The present invention relates to displayable-information management systems each including a displayable-information management apparatus that retains displayable information and one or more display apparatuses with which the displayable information can be read without using the displayable-information management apparatus, and relates to programs for the systems.

2. Description of the Related Art

To date, reading displayable information such as documents created using personal computers (PCs) and images acquired from websites is mainly performed using PC displays. On the other hand, highly portable and highly visible display apparatuses such as electronic paper have been developed recently, and opportunities to read displayable information stored in PCs on display apparatuses other than the PCs have been increasing.

However, when a user attempts to read displayable information retained by a displayable-information management apparatus such as a PC on a display apparatus such as electronic paper such that the displayable-information management apparatus, the displayable-information management apparatus may determine that the displayable information has been read even when, for example, the displayable information is displayed on the displayable-information management apparatus only for the purpose of verification rather than for actual reading or consumption. This may result in difficulties in determining a read or unread status of the displayable information (e.g., whether the displayable information has been read).

### SUMMARY

The present invention provides a displayable-information management system and program for managing a read/unread status of displayable information in an integrated manner by updating read/unread status information when the displayable information is read on specific apparatuses.

According to a first aspect of the present disclosure, a displayable-information management system includes a displayable-information management apparatus that retains displayable information and at least one display apparatus with which the displayable information can be read. In one example, the displayable information can be read without using the displayable-information management apparatus. In a particular example, reading the displayable information without using the displayable-information management apparatus may include reading the displayable information without communicating with the management apparatus and/or without using a display of the displayable-information management apparatus.

In one or more arrangements, the displayable-information management apparatus includes a first storage unit that stores the displayable information and read/unread status information indicating read/unread statuses of the displayable information items. The displayable-information management apparatus further includes a first display unit that displays the displayable information and the read/unread status information, an information exchange unit that exchanges the displayable information and the read/unread status information between the displayable-information management apparatus and the display apparatus, and a first read/unread status information update unit that updates the read/unread status information.

The display apparatus, on the other hand and in one or more arrangements, includes a displayable-information acquisition unit that acquires the displayable information and the read/unread status information corresponding to the displayable information from the displayable-information management apparatus. The display apparatus may further include a second storage unit that stores the displayable information and the read/unread status information acquired by the displayable-information acquisition unit, a second display unit that displays the displayable information, a read/unread determination unit that determines whether or not the displayable information has been read. In one example, when the read/unread determination unit determines that the displayable information has been read, a second read/unread status information update unit may update the read/unread status information corresponding to the displayable information. The display apparatus may also include a read/unread status information transfer unit that transfers the read/unread status information or information indicating that the read/unread status information has been updated to the displayable-information management apparatus. According to one or more configurations, the first read/unread status information update unit of the displayable-information management apparatus might only update the read/unread status information of the displayable information when the first read/unread status information update unit acquires the updated read/unread status information or the information indicating that the read/unread status information has been updated from the display apparatus using the information exchange unit.

According to a second aspect of the present invention, a program causes a computer to operate as the units of the displayable-information management apparatus in the above-described displayable-information management system. The program may include one or more computer readable instructions stored on one or more computer readable media.

According to a third aspect of the present invention, a program causes a computer to operate as the units of the display apparatus in the above-described displayable-information management system. The program may include one or more computer readable instructions stored on one or more computer readable media.

According to a fourth aspect of the present invention, a displayable-information management system includes a plurality of display apparatuses each including a storage unit that stores displayable information associated with read/unread status information indicating read/unread statuses of the displayable information, a display unit that displays the displayable information and an information exchange unit that exchanges the displayable information and the read/unread status information with other apparatuses. Additionally, each of the display apparatuses may also include a read/unread determination unit that determines whether the displayable information has been read, and a read/unread status information update unit that updates the read/unread status information for displayable information when the read/unread determination unit determines that the displayable information has been read. In one arrangement, the displayable-information management system is configured to manage the read/unread status of the displayable information even when the displayable information retained in one of the display apparatuses is read on the display apparatus or the other apparatuses. Additionally or alternatively, the read/unread status information update unit might only update the read/unread status information of the displayable information when the read/unread determination unit determines that the displayable information has been read on a specific display apparatus. With the above-described systems, apparatuses and processes, information indicating whether the displayable information has been read can be managed in an integrated manner.

According to the first, second, and third aspects of the present disclosure, the read/unread status information of displayable information might only be updated or changed upon the read/unread status information being updated to a “read” status by the at least one display apparatus. For example, the read/unread status information might only be updated when the displayable information is read on the at least one display apparatus. Accordingly, the read/unread status information can be managed in an integrated manner.

According to the fourth aspect of the present invention, the read/unread status information corresponding to the displayable information is updated only when the displayable information is read on one or more specific display apparatuses. With this, the information indicating whether the displayable information has been read can be managed in an integrated manner.

### BRIEF DESCRIPTION OF THE DRAWINGS

FIG. 1 illustrates a system configuration of a displayable-information management system according to a first embodiment.

FIG. 2 is a schematic view of a displayable-information management apparatus used in the displayable-information management system according to the first embodiment.

FIG. 3 is a schematic view of a display apparatus used in the displayable-information management system according to the first embodiment.

FIGS. 4A to 4D illustrate a process performed by the displayable-information management system according to the first embodiment.

FIG. 5 is a schematic view of the displayable-information management apparatus according to the first embodiment.

FIG. 6 illustrates example read/unread statuses of displayable information items displayed on a display unit of the displayable-information management apparatus according to a second embodiment.

FIG. 7 illustrates example read/unread statuses of displayable information items displayed on the display unit of the displayable-information management apparatus according to a third embodiment.

FIG. 8 illustrates an example read/unread status information item displayed on the display unit of the displayable-information management apparatus according to the first embodiment.

FIG. 9 is a schematic view of the display apparatus according to the first embodiment.

FIG. 10 illustrates an example list screen of displayable information displayed on the display unit of the display apparatus according to the first embodiment.

FIG. 11 illustrates an example warning displayed on the display unit of the display apparatus according to the first embodiment.

FIG. 12 illustrates an example mode setting screen displayed on the display unit of the display apparatus according to the first embodiment.

FIG. 13 illustrates an example specific-user selection screen displayed on the display unit of the display apparatus according to the first embodiment.

FIG. 14 is a flow chart illustrating a main process performed by the displayable-information management apparatus according to the first embodiment.

FIG. 15 is a flow chart illustrating a main process performed by the display apparatus according to the first embodiment.

FIG. 16 is a flow chart illustrating a key-input standby process performed by the display apparatus according to the first embodiment.

FIG. 17 is a flow chart illustrating a displayable information deletion process performed by the display apparatus according to the first embodiment.

FIG. 18 is a flow chart illustrating a page turning process performed by the display apparatus according to the first embodiment.

### DETAILED DESCRIPTION

Embodiments of a displayable-information management system of the present invention will now be described with reference to the drawings.

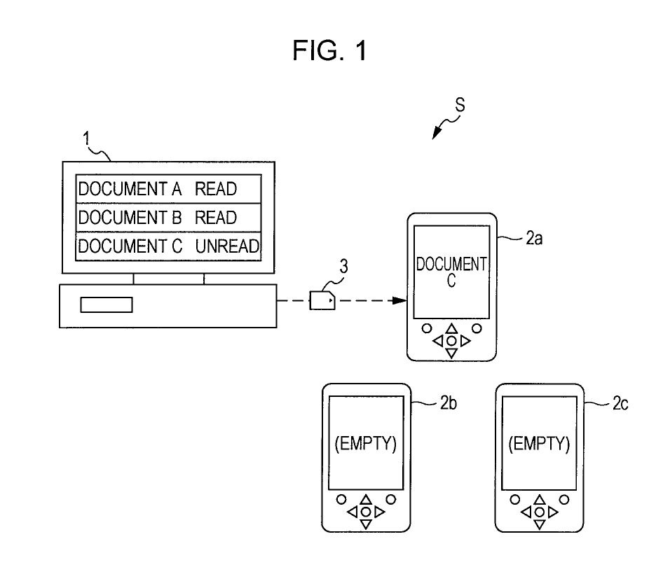

As shown in FIG. 1, a displayable-information management system S according to this embodiment includes a displayable-information management apparatus 1 that retains displayable information and display apparatuses 2 (herein, display apparatuses 2a, 2b, and 2c) with which the displayable information retained by the displayable-information management apparatus 1 can be read without using the displayable-information management apparatus 1.

The term “displayable information” may include information such as images and texts in the formats readable on the display apparatuses 2. In one or more examples, the displayable information may be electronic in nature. The displayable information stored in the displayable-information management apparatus can be moved to, for example, the display apparatus 2a via a non-volatile memory card 3 so that the displayable information retained in the displayable-information management apparatus 1 can be read using the display apparatus 2a. In other arrangements, the displayable information may be electronically transmitted through a network or a direct connection.

Although this embodiment includes the three display apparatus 2a, 2b, and 2c, the number of the display apparatuses 2 is not limited to this. For example, greater or fewer display apparatuses 2 may be used in such a system S.

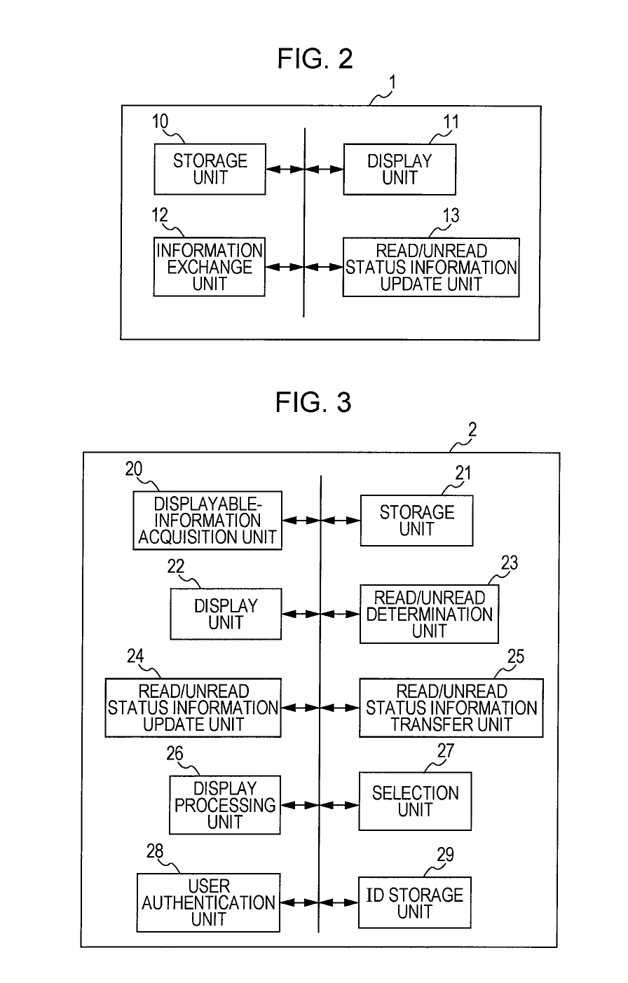

As shown in FIG. 2, the displayable-information management apparatus 1 in the displayable-information management system S according to this embodiment includes a storage unit 10, a display unit 11, an information exchange unit 12, and a read/unread status information update unit 13.

As shown in FIG. 3, the display apparatuses 2 each include a displayable-information acquisition unit 20, a storage unit 21, a display unit 22, a read/unread determination unit 23, a read/unread status information update unit 24, a read/unread status information transfer unit 25, a display processing unit 26, a selection unit 27, a user authentication unit 28, and an ID storage unit 29.

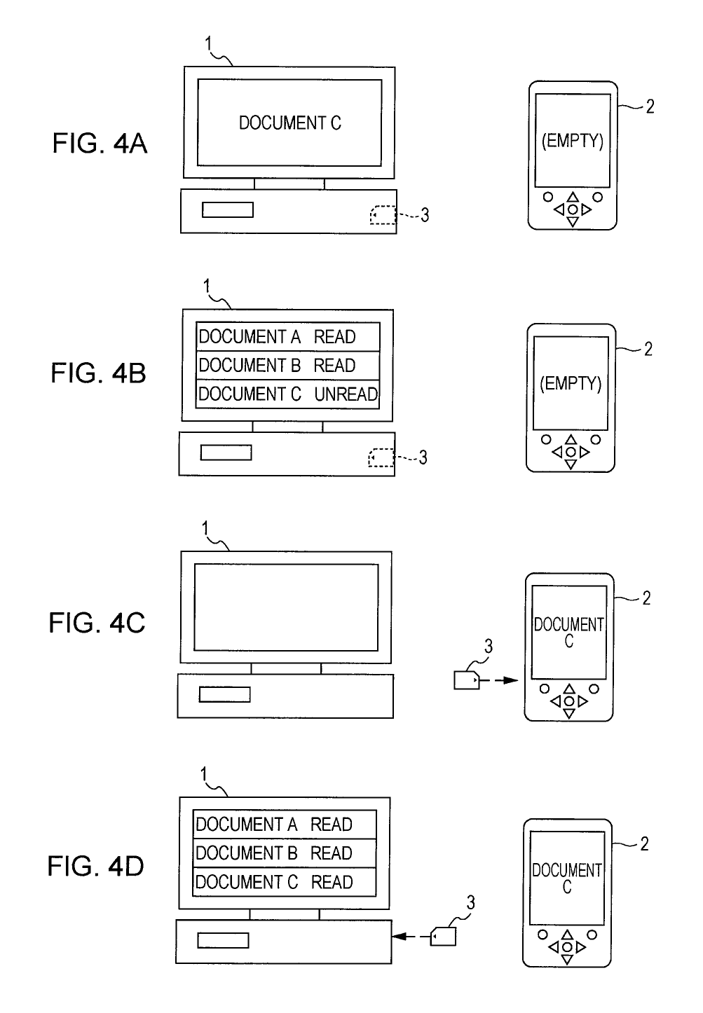

That is, the displayable-information management apparatus 1 stores displayable information and read/unread status information corresponding to the displayable information in the storage unit 10. As shown in FIG. 4A, any displayable information item (e.g., “Document C”) can be displayed on the display unit 11 so that the user can read it. The term “read/unread status information” herein refers to information indicating the read/unread statuses of the displayable information items. For example, the read/unread status information is used for determining whether or not the displayable information has been read (“read” or “unread”). The read/unread status information is associated with the displayable information, and stored in the storage unit 10. In the displayable-information management system S according to this embodiment, the read/unread status information corresponds to information used for determining whether the displayable information (e.g., Document C) has been read or is unread. However, information such as “all pages read”, “read up to page X”, and “read for X minutes” can also be used as the read/unread status information.

As shown in FIG. 4B, the read/unread status information can also be displayed on the display unit 11 of the displayable-information management apparatus 1 so that the user can read it.

Next, when the user attempts to read the displayable information stored in the storage unit 10 of the displayable-information management apparatus 1 on a display apparatus 2, the displayable information and the read/unread status information corresponding to the displayable information are transferred to the display apparatus 2 via the information exchange unit 12 of the displayable-information management apparatus 1 and the memory card 3. At this moment, the display apparatus 2 acquires the displayable information and the read/unread status information corresponding to the displayable information from the displayable-information management apparatus 1 using the displayable-information acquisition unit 20, and stores the acquired displayable information and read/unread status information in the storage unit 21 as required.

Subsequently, as shown in FIG. 4C, the display apparatus 2 displays the displayable information stored in the storage unit 21 or in the memory card 3 on the display unit 22.

In this manner, the user can read the displayable information retained in the displayable-information management apparatus 1 using the display apparatus 2. When the displayable-information management apparatus 1 is a desktop PC and the display apparatus 2 is a mobile terminal, for example, the user can move only necessary displayable information items among a large amount of displayable information retained in the displayable-information management apparatus 1 to the display apparatus 2 so that the user can read the necessary information items while he/she is away from his/her desk while, for example, commuting.

In this embodiment, the display apparatus 2 includes the read/unread determination unit 23 (FIG. 3) that determines whether or not the displayable information has been read. When the read/unread determination unit 23 determines that the displayable information has been read, the read/unread status information update unit 24 updates the read/unread status information corresponding to the displayable information from “unread” to “read”.

Next, the display apparatus 2 transfers the read/unread status information to the displayable-information management apparatus 1 via the read/unread status information transfer unit 25 (FIG. 3) and the memory card 3 (see FIG. 4D), and the displayable-information management apparatus 1 receives the read/unread status information via the memory card 3 and the information exchange unit 12.

The displayable-information management apparatus 1 includes the read/unread status information update unit 13 (FIG. 3) that updates the read/unread status information. The read/unread status information update unit 13 updates the read/unread status information of the displayable information from “unread” to “read” only upon the read/unread status information acquired by the displayable-information management apparatus has been updated to “read” by the display apparatus 2 using the information exchange unit 12.

That is, the displayable-information management apparatus 1 in the displayable-information management system S (FIG. 1) according to this embodiment does not update the read/unread status information using the read/unread status information update unit 13 (see FIG. 4B) even when the displayable information is displayed on the displayable-information management apparatus (see FIG. 4A). Instead, in one or more arrangements, the management apparatus 1 might only update the read/unread status information stored in the displayable-information management apparatus from “unread” to “read” when the displayable-information management apparatus acquires (or upon the displayable-information management apparatus acquiring) the read/unread status information that has been updated to “read” by the display apparatus 2 (e.g., only when the displayable information was read on the display apparatus 2; see FIG. 4D).

With this configuration, for example, it is not determined that the displayable information has been read even when the displayable information has been displayed on the displayable-information management apparatus 1 only for the purpose of verification. Therefore, the read/unread status information of the displayable information can be prevented from being updated from “unread” to “read” (e.g., in the displayable information management apparatus 1 of FIG. 1) when the displayable information is displayed on the displayable-information management apparatus 1 only for the purpose of verification.

Referring again to FIG. 3, the display apparatus 2 includes the selection unit 27 that selects a determination mode of the display apparatus 2 from between a first mode in which the read/unread statuses of the displayable information items are determined by the read/unread determination unit 23 and a second mode in which the read/unread statuses of the displayable information items are not determined by the read/unread determination unit 23 of the display apparatus 2.

With this configuration, information indicating whether the displayable information has been read when viewed on one of more of the display apparatuses 2 can be managed more exactly by selecting the first mode or the second mode using the selection unit 27 even with the plurality of display apparatuses 2.

Moreover, the read/unread determination unit 23 of the display apparatus 2 can also determine that the displayable information has been read when the displayable information that has been read is specific displayable information.

That is, the display apparatus 2 includes the user authentication unit 28 for user identification, and the read/unread determination unit 23 can determine that the displayable information has been read only when specific displayable information is read by a specific user authenticated by the user authentication unit 28.

Furthermore, the display apparatus 2 includes the ID storage unit 29 that stores a unique ID of the apparatus, and the read/unread determination unit 23 can determine that the displayable information has been read only when displayable information, associated with an ID corresponding to the unique ID and defined as the specific displayable information, has been read.

With this configuration, it is not determined that the displayable information has been read even when other users read and/or other devices are used to read the displayable information, and the information indicating whether or not the displayable information has been read can be managed more correctly.

In the displayable-information management system S according to this embodiment, when the displayable information includes multiple pages, the read/unread determination unit 23 of the display apparatus 2 determines that the displayable information has been read when the last page of the displayable information is displayed on the display unit 22.

However, the display apparatus 2 may also determine that the displayable information has been read when the first page of the displayable information is displayed or all the pages of the displayable information are displayed by changing settings. According to another alternative, display apparatus 2 may determine that displayable information has been read when a predefined number or percentage of pages has been read (e.g., 3 pages, 10 pages, 50% of pages, 25% of pages, etc.).

In this embodiment, each displayable information item has a file name including character information indicating whether the displayable information has been read or is unread so that the read/unread status information is associated with the displayable information. This facilitates the determination of whether the displayable information has been read or is unread. The status information might also be stored in metadata that may be displayed upon a user hovering over or otherwise interacting with a file.

The read/unread status information can include date information indicating when the displayable information was read first, last, or first and last on the display apparatus.

Moreover, the display apparatus 2 according to this embodiment can include, for example, a mobile terminal having an electrophoretic display panel such as electronic paper.

In this manner, the display apparatus 2 can be made more suitable for the system by incorporating a mobile terminal with high portability and high visibility as the display apparatus 2.

Moreover, when the displayable information stored in the storage unit 21 of the display apparatus 2 is about to be deleted without the read/unread status information corresponding to the displayable information having been updated to “read,” the display processing unit 26 of the display apparatus 2 displays a warning that the displayable information is unread on the display unit 22. This can prevent users from accidentally deleting unread displayable information. A user may then be required to confirm deletion or acknowledge the warning prior to completing the deletion process.

Example configurations and operations of a displayable-information management system such as displayable-information management system S of FIG. 1 will now be described with reference to the drawings.

Example Configuration of a Displayable-Information Management System

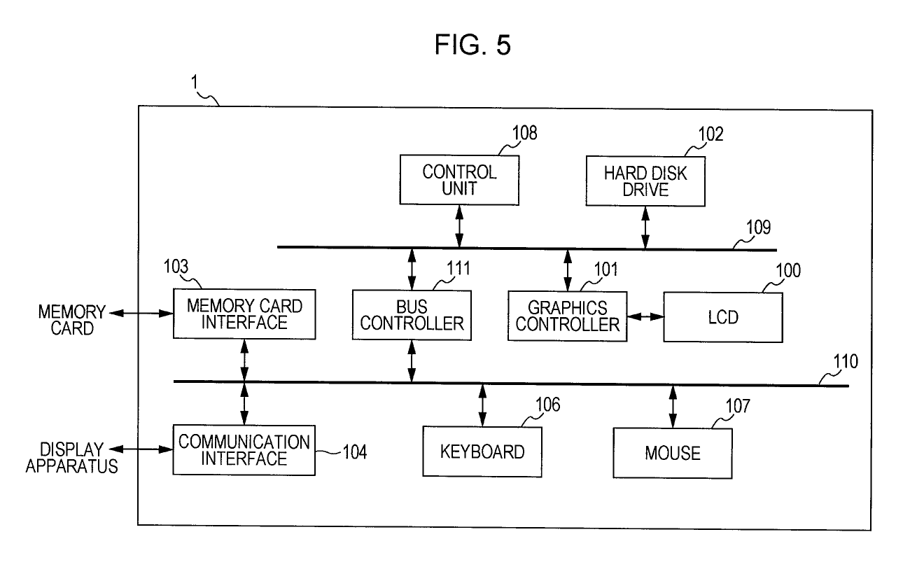

The displayable-information management apparatus 1 according to this embodiment can include a general personal computer or a dedicated terminal. As shown in FIG. 5, the displayable-information management apparatus 1 includes an LCD 100 serving as a display unit, a graphics controller 101 that drives the LCD 100, a hard disk drive 102 (corresponding to the storage unit) that stores, for example, various data, and a memory card interface 103 (corresponding to the information exchange unit) that exchanges the displayable information and the like with the display apparatuses 2 via the memory card 3. The displayable-information management apparatus 1 may further include a communication interface 104 (corresponding to the information exchange unit) that communicates with the display apparatuses 2 via a communication path, a keyboard 106 and a mouse 107 with which users can input predetermined information, and a control unit 108 that controls the entire displayable-information management apparatus 1. These components are connected to each other via a first bus 109 and a second bus 110. In addition, a bus controller 111 exchanges data between the first bus 109 and the second bus 110.

The hard disk drive 102 functions as the storage unit, and stores various application programs such as an operating system (OS) program of the displayable-information management apparatus 1, word processing software, presentation software, spreadsheet software, and graphics software, and document information, image information, and the like produced by the application programs in addition to the displayable information and the read/unread status information corresponding to the displayable information.

Displayable information in this embodiment may include information converted from the document information, the image information, and the like into formats readable on and/or specified to display apparatuses 2, and read/unread status information (information indicating “read” or “unread”) that may be produced during the conversion. In one example, a document may be converted from a PDF or MICROSOFT WORD format to a display apparatus-compatible format if the display apparatus is not compatible with PDF or MICROSOFT WORD. In one specific example, the converted format may be specific to the display apparatus. Further, the conversion may be performed by a displayable information management device (e.g., displayable information management apparatus 1) or a display apparatus (e.g., display apparatuses 2) or both. At the moment a version of the document readable on the display apparatuses 2 is produced, the read/unread status information is set to a default setting of “unread”.

Moreover, the hard disk drive 102 stores a displayable-information management program serving as a processing program for the displayable-information management system S according to this embodiment in addition to the above-described application programs.

The displayable-information management program can be, for example, downloaded from a server (not shown) connected to the communication path to the hard disk drive 102 via the communication interface 104, or can be read into the hard disk drive 102 from a recording medium such as a CD-ROM including the program via a recording medium drive (not shown).

The memory card interface 103 exchanges the displayable information, the read/unread status information, and the like with the non-volatile memory card 3. The memory card interface 103 can write the displayable information, the read/unread status information, and the like from the memory card 3, or can read out the displayable information, the read/unread status information, and the like stored in the memory card 3.

The communication interface 104 can include a USB interface that can communicate with external apparatuses, and the control unit 108 uses the communication interface 104 when acquiring the displayable information, the read/unread status information, and the like from the display apparatuses 2 or when communicating with external computer devices. The communication interface 104 can include a wireless or wired LAN interface instead of or in addition to the USB interface.

The control unit 108 includes, for example, a CPU, ROM, and RAM. The CPU may be configured to read out and execute the displayable-information management program stored in the hard disk drive 102 so that the displayable-information management apparatus 1 functions as the image display unit, the read/unread status information update unit, and the like.

The CPU of the control unit 108 functioning as the image display unit generates displayable information on the basis of document information, image information, and the like. The generated displayable information is displayed on the LCD 100 as images based on the displayable information by the LCD 100 serving as the display unit and the graphics controller 101.

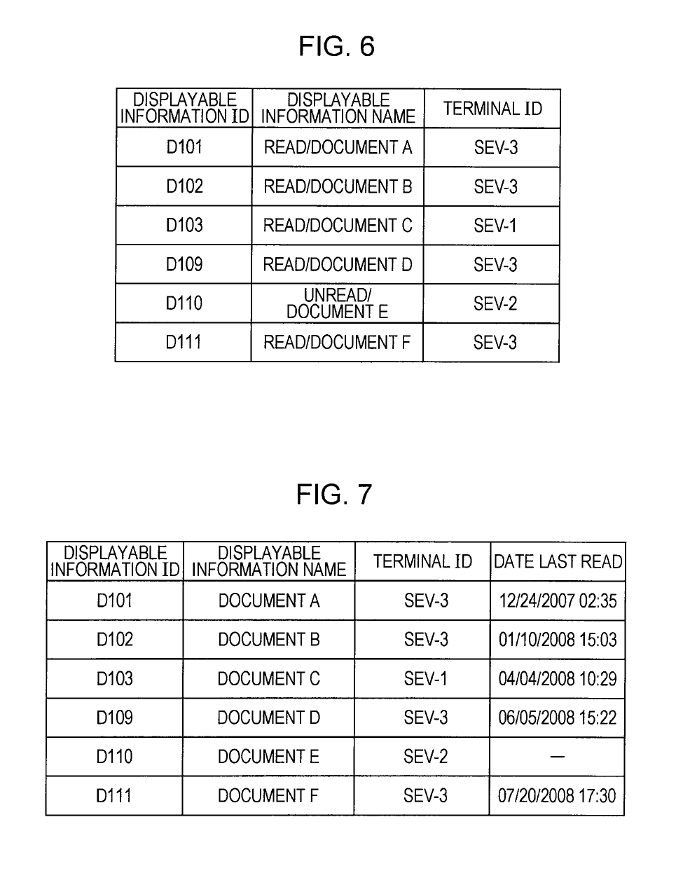

Moreover, the CPU of the control unit 108 functioning as the image display unit generates a list screen indicating the read/unread statuses of the displayable information items on the basis of the displayable information and the read/unread status information corresponding to the displayable information, and displays the generated list screen on the LCD 100. As shown in FIG. 6, the list screen includes file names of the displayable information items (displayable information names) and unique IDs of the display apparatuses 2 (terminal IDs; described below) associated with unique IDs of the displayable information items (displayable information IDs).

In some arrangements, the terminal IDs and the displayable information IDs may be transferred to the display apparatuses 2 together with the displayable information and the read/unread status information via the memory card 3.

In this embodiment, the read/unread status information is associated with the displayable information by, for example, defining character information indicating whether the displayable information has been read or is unread, for example, “read/document A” and “unread/document E”, as the file names of the displayable information items. In additional or alternative arrangements, the file names may be displayed in different fonts, font sizes, styles, colors and/or other appearance attributes to denote read or unread status. For example, a file name may be displayed in bold if unread and non-bolded when read.

With this configuration, it can be easily determined whether the displayable information has been read or is unread.

The displayable-information management apparatus 1 can also define date information indicating when the displayable information was read first, last, or first and last on the display apparatuses 2 as the read/unread status information by changing settings.

In this case, the list screen generated by the control unit 108 functioning as the image display unit includes, for example, the displayable information names, the terminal IDs, and dates last read of the displayable information associated with the displayable information IDs as shown in FIG. 7.

With this configuration, users can obtain date information indicating when the displayable information was read at the same time as when they determine whether the displayable information has been read or is unread. This allows more detailed management of the displayable information.

Although it can be determined whether the displayable information has been read or is unread on the list screen as described above in the displayable-information management system S according to this embodiment (e.g., based on the file name), character information indicating that the displayable information has been read or is unread can be displayed on the LCD 100 together with the displayable information.

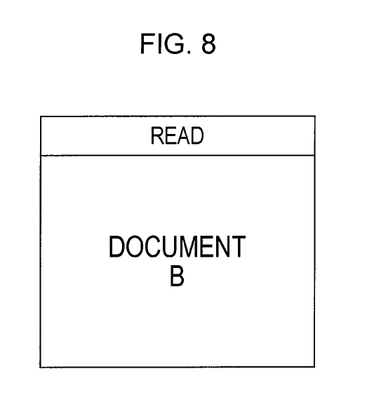

That is, when a displayable information item, “document B”, is displayed on the LCD 100, for example, character information of “read” is displayed on an upper portion of the displayable information displayed on the LCD 100 as shown in FIG. 8. With this configuration, a viewer may easily determine whether the displayable information has been read or is unread.

Moreover, the CPU of the control unit 108 functioning as the read/unread status information update unit updates the read/unread status information corresponding to the displayable information.

In particular, in this embodiment, the CPU of the control unit 108 functioning as the read/unread status information update unit updates the read/unread status information corresponding to the displayable information to “read” only when the CPU acquires the read/unread status information updated to “read” from the display apparatuses 2.

Example Configuration of a Display Apparatus

Next, an example configuration of the display apparatuses 2 will be described.

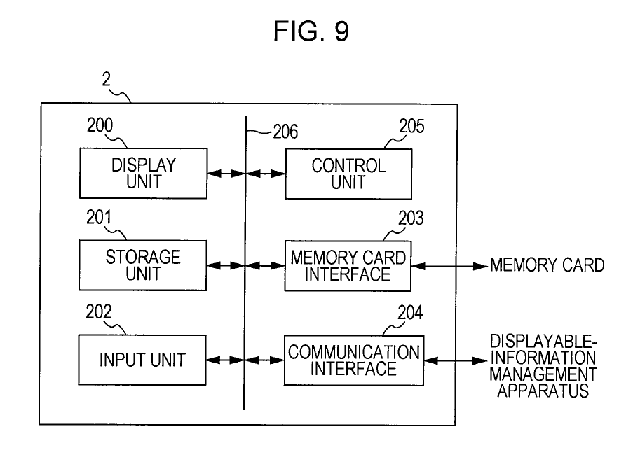

The display apparatuses 2 in this embodiment can include mobile terminal devices. As shown in FIG. 9, the display apparatuses 2 each include a display unit 200 for visually displaying various information including documents, images, videos, text, messages and the like, a storage unit 201 (corresponding to the storage unit and the ID storage unit) that stores, for example, various data, an input unit 202 with which users can input predetermined information, a memory card interface 203 (corresponding to the displayable-information acquisition unit and the read/unread status information transfer unit) that exchanges the displayable information, the read/unread status information, and the like with the displayable-information management apparatus 1 via the memory card 3. Each of the display apparatuses 2 may further include a communication interface 204 (corresponding to the displayable-information acquisition unit and the read/unread status information transfer unit) that communicates with the displayable-information management apparatus 1 via the communication path, and a control unit 205 that controls the entire display apparatus 2. These components are connected to each other via a bus 206.

The display unit 200 can include a so-called electrophoretic display panel, which is mainly used as a display unit of electronic paper that displays images using electrophoresis of charged particles.

As described above, the displayable-information management system S according to this embodiment uses mobile terminals having electrophoretic display panels with high portability and high visibility as the display apparatuses 2. This configuration can make the display apparatuses more suitable for the system.

The storage unit 201 may store, for example, the displayable information and the read/unread status information corresponding to the displayable information, user IDs used for user authentication and passwords associated with the user IDs, the terminal ID serving as the unique ID of the apparatus, and various setting information.

Moreover, the storage unit 201 stores a displayable-information management program serving as a processing program for the displayable-information management system S according to this embodiment.

The displayable-information management program can be, for example, downloaded from a server (not shown) connected to the communication path to the storage unit 201 via the communication interface 204, or can be read into the storage unit 201 from a recording medium such as a CD-ROM including the program via a recording medium drive (not shown).

The input unit 202 includes UP and DOWN buttons that may be used for selecting displayable information items users want to read, LEFT and RIGHT buttons that may be used for turning pages during reading of the displayable information, an ENTER button for confirming various operations, a DISPLAY button used for displaying a list display screen on the display unit 200, and a DELETE button used for deleting the displayable information.

The memory card interface 203 exchanges the displayable information, the read/unread status information, and the like with the non-volatile memory card 3. The memory card interface 203 can write the displayable information, the read/unread status information, and the like in the memory card 3, or can read out the displayable information, the read/unread status information, and the like stored in the memory card 3.

The communication interface 204 can include a USB interface that can communicate with external apparatuses, and the control unit 205 uses the communication interface 204 when acquiring the displayable information, the read/unread status information, and the like from the displayable-information management apparatus 1 or when communicating with external computer devices. The communication interface 204 can include a wireless or wired LAN interface instead of the USB interface.

The control unit 205 includes, for example, a CPU, ROM, and RAM, and the CPU reads out and executes the displayable-information management program (e.g., computer readable instructions) stored in the storage unit 201 so that the display apparatus 2 functions as the read/unread determination unit, the read/unread status information update unit, the display processing unit, the selection unit, the user authentication unit, and the like.

The CPU of the control unit 205 functioning as the read/unread determination unit determines whether or not the displayable information has been read.

In this embodiment, the control unit 205 functioning as the read/unread determination unit determines that the displayable information has been read when the read displayable information is specific displayable information.

Specific displayable information may include displayable information associated with a terminal ID of the display apparatus 2 (see FIG. 6). That is, the control unit 205 may determine that the displayable information has been read only when the read displayable information is associated with the terminal ID of the apparatus on which the displayable information was read or viewed.

With this configuration, when a user owns display apparatuses 2a, 2b, and 2c, for example, he/she can divide the displayable information into parts so that he/she can read the information items on the respective display apparatuses 2. In this manner, information indicating whether or not the displayable information has been read can be managed in more detail (e.g., with respect to the individual display apparatuses 2).

Moreover, the CPU of the control unit 205 functioning as the user authentication unit together with the storage unit 201 and the input unit 202 may operate to identify users. That is, the control unit 205 displays alphanumeric characters on the display unit 200, requests users to input their user IDs and passwords using the input unit 202, and identifies users on the basis of the user IDs and the passwords input by the users and user IDs and passwords stored in the storage unit 201.

In addition, the control unit 205 functioning as the read/unread determination unit determines that the displayable information has been read only when specific displayable information is read by a specific authenticated user.

With this configuration, it is not determined that the displayable information has been read even when other users (e.g., other than specific predefined users) read the displayable information, and thus, the information indicating whether or not the displayable information has been read can be managed accordingly.

When the displayable information includes multiple pages, the control unit 205 functioning as the read/unread determination unit determines that the displayable information has been read when the last page of the displayable information is displayed on the display unit 200.

That is, it is not determined that the displayable information has been read as long as the last page is not displayed on the display unit 200, and the information indicating whether or not the user has read the displayable information can be managed according to a variety of parameters and requirements.

Herein, the display apparatus 2 can determine that the displayable information has been read when the first page of the displayable information is displayed on the display unit 200 by changing settings. With this configuration, it can be determined that the displayable information has been read when only the first page of the displayable information has been read by the user.

Moreover, the display apparatus 2 can determine that the displayable information has been read when all the pages of the displayable information are displayed on the display unit 200 by changing settings. With this configuration, it is not determined that the displayable information has been read as long as all the pages are not displayed on the display unit 200, and it can be determined whether or not the user has read the displayable information more reliably. Alternative methods and guidelines for determining whether displayable information has been read may be defined. For example, displayable information might not be considered read until a certain number or percentage of pages have been read or once a user has viewed a particular page (e.g., regardless of whether any or all preceding pages were viewed).

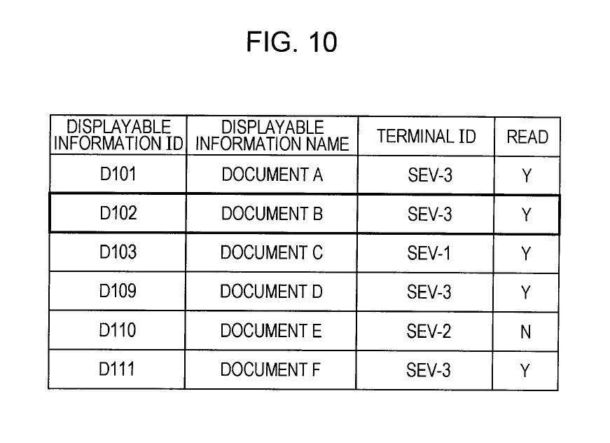

Moreover, the CPU of the control unit 205 functioning as the display processing unit together with the display unit 200 generates a list screen indicating the read/unread statuses of the displayable information items on the basis of the displayable information, the read/unread status information corresponding to the displayable information, and the like stored in the storage unit 201 or the memory card 3, and displays the generated list screen on the display unit 200. As shown in FIG. 10, the list screen includes displayable information IDs, displayable information names, and terminal IDs associated with the read/unread status information.

In this embodiment, the read/unread status information is indicated by alphabets of “Y” and “N”. That is, the read/unread status information is indicated by “Y” when the displayable information has been read, and is indicated by “N” when the displayable information is unread. Other types of indicators may also be used including “U” for unread and “R” for read or through the use of alphanumeric and non-alphanumeric symbols.

In this list screen, the read/unread status information can be associated with the displayable information by defining character information indicating whether the displayable information has been read or is unread as the file names of the displayable information items as in the list screen displayed on the displayable-information management apparatus 1 (see FIG. 6). Moreover, date information indicating when the displayable information was read first, last, or first and last on the display apparatus 2 can be defined as the read/unread status information (see FIG. 7). Furthermore, character information indicating whether the displayable information has been read or is unread can be displayed on an upper portion of the displayable information (see FIG. 8) without the read/unread status information being displayed in the list screen.

In the display apparatus 2 according to this embodiment, users select the displayable information to be read on this list screen.

Moreover, the CPU of the control unit 205 functioning as the read/unread status information update unit together with the storage unit 201 updates the read/unread status information corresponding to the displayable information from “unread” to “read” when it is determined that the displayable information has been read.

That is, the control unit 205 may update the read/unread status information corresponding to the displayable information stored in the storage unit 201 or the memory card 3 from “unread” to “read” when the last page (or other predefined page or number or percentage of pages) of the specific displayable information is read by a specific user authenticated by the user authentication unit in this embodiment.

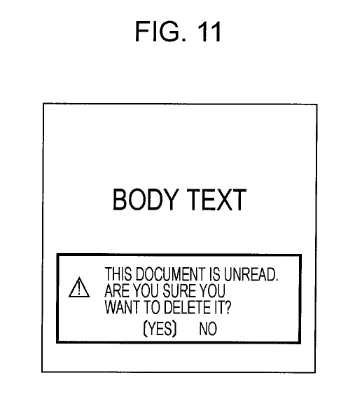

Moreover, when the displayable information stored in the storage unit 201 is about to be deleted without the read/unread status information corresponding to the displayable information having been updated to “read”, the CPU of the control unit 205 functioning as the display processing unit together with the display unit 200 displays a warning that the displayable information is unread on the display unit 200 as shown in FIG. 11. As noted previously, the deletion process might not be performed until a user confirms the deletion (after the warning has been displayed) or provides some acknowledgment of the warning.

The warning includes fields (“YES” and “NO”) with which the user can select whether or not he/she accepts the deletion of the displayable information by operating the input unit 202.

Moreover, the CPU of the control unit 205 functioning as the selection unit together with the storage unit 201 and the input unit 202 selects a determination mode for a display apparatus from between a first mode in which the read/unread statuses of the displayable information items are determined and a second mode in which the read/unread statuses of the displayable information items are not determined on the display apparatus.

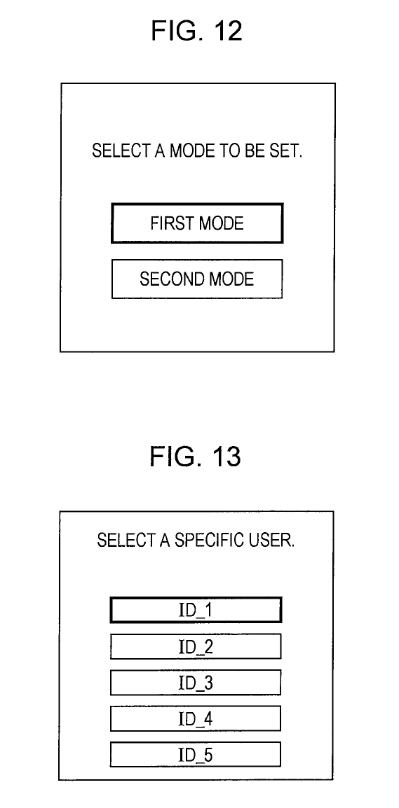

In one arrangement, the user may control whether the display apparatus 2 is used in the first mode or in the second mode on a mode selection screen shown in FIG. 12 by operating the UP, DOWN, and ENTER buttons of the input unit 202.

In the above example arrangement, when the second mode is selected by the above-described operation, the control unit 205 does not function as the read/unread determination unit, and as a result, the read/unread status information corresponding to the displayable information is not updated even when the last page of the specific displayable information has been read by a specific user authenticated by the user authentication unit.

With this configuration, the read/unread status information of the displayable information can be updated only when the displayable information is read on a specific display apparatus 2 even when a plurality of display apparatuses 2 exist.

That is, when a user has a display apparatus 2 for reading and another display apparatus 2 for storage, for example, the display apparatus 2 for reading is set to the first mode, and the other display apparatus 2 for storage is set in the second mode. With this, the read/unread status information is not updated until the displayable information has been read on the display apparatus 2 for reading even when the displayable information has been browsed on the display apparatus 2 for storage only for the purpose of verification, and information indicating whether or not the displayable information has been read can be managed more specifically.

Moreover, the CPU of the control unit 205 functioning as the selection unit together with the storage unit 201 and the input unit 202 selects a specific user from a plurality of users registered on the basis of their user IDs. For example, the user may select a specific user ID from a plurality of user IDs (herein, from ID_1 to ID_5) displayed on the display unit 200 in a specific-user selection screen shown in FIG. 13 by operating the UP, DOWN, and ENTER buttons of the input unit 202.

Example Operation of a Displayable-Information Management Apparatus

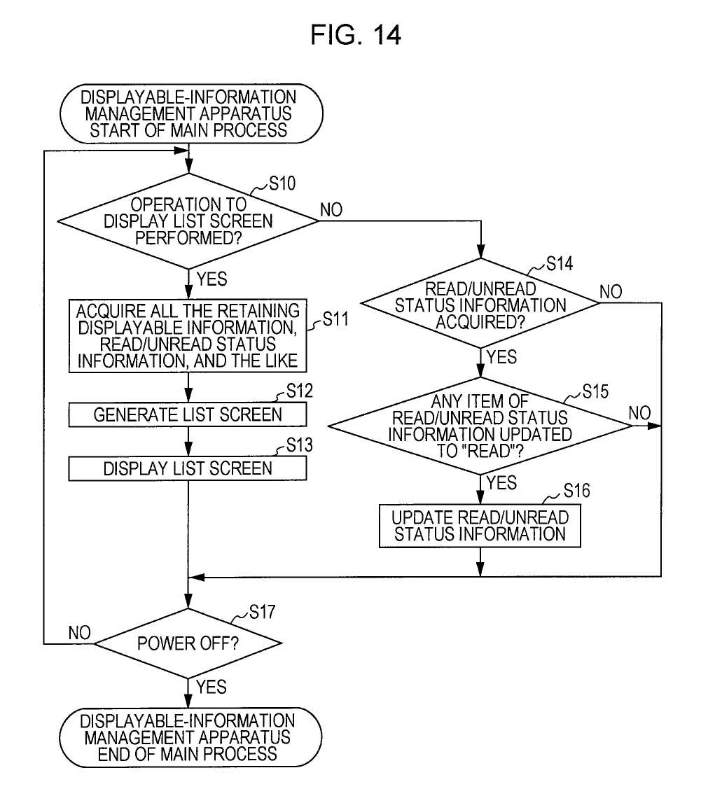

Next, an example operation of the displayable-information management apparatus 1 will be described with reference to FIG. 14. The following processes are performed by the control unit 108 of the displayable-information management apparatus 1 functioning as the above-described units.

As shown in FIG. 14, when a power switch (not shown) of the displayable-information management apparatus 1 is turned on, the control unit 108 of the displayable-information management apparatus 1 determines whether an instruction to display a list screen is issued (Step S10). In one example, determining whether to display a list screen may be based on whether a user operates the mouse 107.

When it is determined that an instruction to display the list screen is issued in this process (e.g., Yes in Step S10), the control unit 108 acquires the displayable information, the read/unread status information corresponding to the displayable information, and the like stored in the hard disk drive 102 (Step S11), generates a list screen on the basis of the acquired information (Step S12), and displays the generated list screen on the LCD 100 (Step S13). With this, the list screen as shown in FIG. 6 is displayed on the LCD 100 of the displayable-information management apparatus 1.

On the other hand, when no instruction to display the list screen is issued in Step S10 (No in Step S10), the control unit 108 determines whether the displayable information and the read/unread status information are acquired from a display apparatus 2 via the memory card 3 (Step S14). The control unit 108 moves the process to Step S15 in response to determining that the displayable information and the read/unread status information are acquired in this process (e.g., Yes in Step S14).

In Step S15, the control unit 108 determines whether or not any read/unread status information items acquired in Step S14 have been updated to “read.” In response to determining that some read/unread status information items have been updated to “read” in this process (e.g., Yes in Step S15), the control unit 108 updates the read/unread status information items stored in the hard disk drive 102 of the displayable-information management apparatus 1 from “unread” to “read” on the basis of the acquired updated read/unread status information and the displayable information corresponding to the read/unread status information (Step S16).

For example, when a document C is unread (see FIG. 4B) and the read/unread status of the document C transferred from the display apparatus 2 via the memory card 3 has been updated to “read,” the control unit 205 updates the read/unread status of the document C stored in the hard disk drive 102 of the displayable-information management apparatus from “unread” to “read”.

In the displayable-information management system S according to this embodiment, the displayable-information management apparatus 1 updates the read/unread status information of the displayable information from “unread” to “read” only when the displayable-information management apparatus 1 acquires the read/unread status information updated to “read” from the display apparatus 2 as described above. With this, information indicating whether the displayable information has been read can be managed in an integrated manner.

The control unit 108 moves the process to Step S17 after the processes in Steps S13 and S16, when the read/unread status information is not acquired in Step S14 (e.g., No in Step S14), or when no read/unread status information item has been updated to “read” in Step S15 (e.g., No in Step S15).

The control unit 108 determines whether or not the power is turned off in Step S17, and moves the process to Step S10 upon determining that the power is not turned off (e.g., No in Step S17). On the other hand, the control unit 108 ends the main processes when it is determined that the power is turned off (e.g., Yes in Step S17).

Example Operation of a Display Apparatus

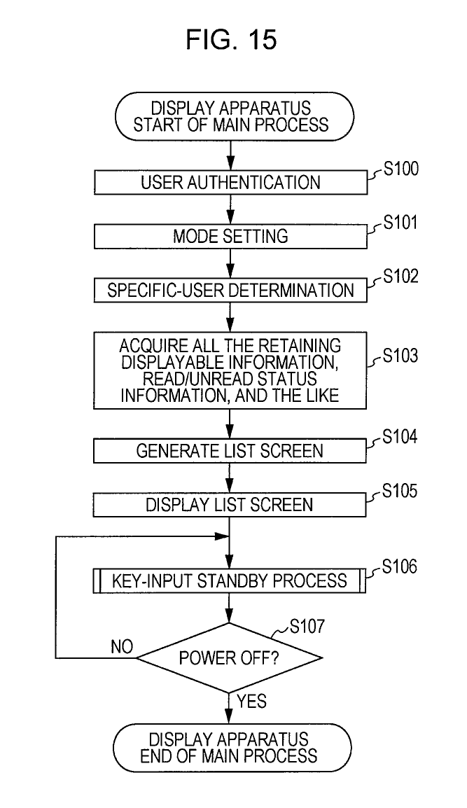

Next, an example operation of a display apparatus 2 will be described with reference to FIGS. 15 to 18. The following processes are performed by the control unit 205 of the display apparatus 2 functioning as the above-described units.

As shown in FIG. 15, when the power switch (not shown) of the display apparatus 2 is turned on, the control unit 205 of the display apparatus 2 performs user authentication (Step S100). The user authentication requires a user to input his/her user ID and password, and identifies the user on the basis of the user ID and the password input by the user and user IDs and passwords stored in the storage unit 201.

After the user authentication in Step S100, the control unit 205 performs mode setting (Step S101). During the mode setting, the control unit 205 first displays the mode selection screen as shown in FIG. 12 on the display unit 200. Subsequently, the control unit 205 determines which of the first mode and the second mode is selected on the basis of inputs to the input unit 202, and stores information indicating which mode is selected in the storage unit 201. For example, the first and second modes may correspond to different instructions regarding whether to update or change the read/unread status of displayable information.

After the mode setting in Step S101, the control unit 205 performs specific-user determination (Step S102). During the specific-user determination, the control unit 205 first displays the specific-user selection screen as shown in FIG. 13 on the display unit 200. Subsequently, the control unit 205 determines which user ID is selected on the basis of inputs to the input unit 202, and stores information indicating which user ID is selected in the storage unit 201.

The processes in Step S101 and Step S102 are not necessarily performed every time the power switch of the display apparatus 2 is turned on, and can be performed, for example, only for the first time the display apparatus is turned on. The set information can be associated with the user ID, and stored in the storage unit 201 such that the mode and the specific user can be set on the basis of the information associated with the user ID authenticated during the user authentication from the second time onward.

Next, the control unit 205 acquires the displayable information, the read/unread status information corresponding to the displayable information, and the like stored in the storage unit 201 or the memory card 3 (Step S103), generates a list screen on the basis of the acquired information (Step S104), and displays the generated list screen on the display unit 200 (Step S105). With this, the list screen as shown in FIG. 10 is displayed on the display unit 200 of the display apparatus 2.

Next, the control unit 205 performs a key-input standby process (Step S106). The key-input standby process includes various processes performed in accordance with inputs to the input unit 202 by the user, and will be described below.

After the process in Step S106, the control unit 205 determines whether the power is turned off, and returns the process to Step S106 upon determining that the power is not turned off (e.g., No in Step S107). On the other hand, the control unit 205 ends the main processes upon determining that the power is turned off (e.g., Yes in Step S107).

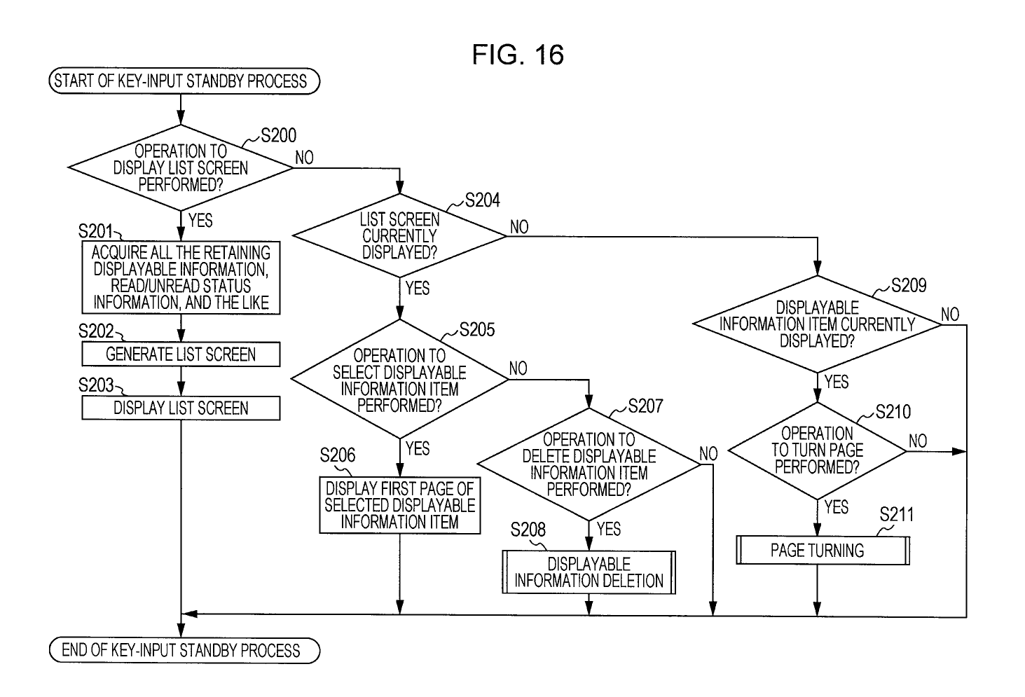

Next, the key-input standby process in Step S106 will be described in detail with reference to FIG. 16.

As shown in FIG. 16, the control unit 205 determines whether an operation to display a list screen has been performed (Step S200) when the key-input standby process starts. The determination may be made based on whether the DISPLAY button of the input unit 202 is pushed down or otherwise selected. In response to determining that the operation to display a list screen is performed in this process (e.g., Yes in Step S200), the control unit 205 acquires the displayable information, the read/unread status information corresponding to the displayable information, and the like stored in the storage unit 201 or the memory card 3 (Step S201), generates a list screen on the basis of the acquired information (Step S202), and displays the generated list screen on the display unit 200 (Step S203).

On the other hand, when the operation to display a list screen is not performed in Step S200 (e.g., No in Step S200), the control unit 205 determines whether a list screen is being displayed (Step S204). In response to determining that a list screen is being displayed in this process (e.g., Yes in Step S204), the control unit 205 moves the process to Step S205.

In Step S205, the control unit 205 determines whether an operation to select a displayable information item has been or is being performed. For example, this determination may be made based on whether a displayable information item is selected on the list screen as shown in FIG. 10 in accordance with inputs to the UP, DOWN, and Enter buttons of the input unit 202. Upon determining that the operation to select a displayable information item is performed in this process (e.g., Yes in Step S205), the control unit 205 displays the first page of the selected displayable information item on the display unit 200 (Step S206).

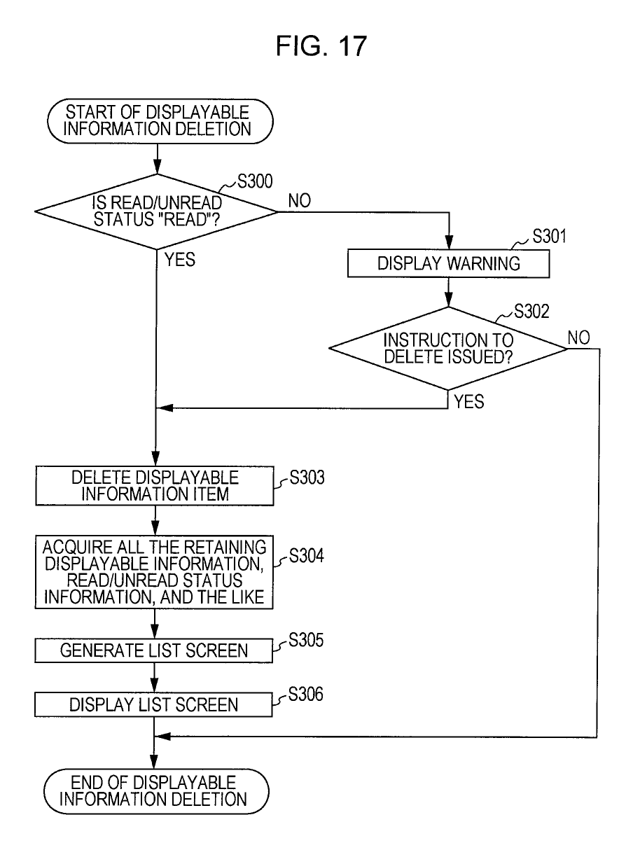

On the other hand, when the operation to select a displayable information item is not performed in Step S205 (e.g., No in Step S205), the control unit 205 determines whether an operation to delete a displayable information item is performed (Step S207). In one example, such a determination may be made based on whether the DELETE button of the input unit 202 is pushed down. In response to determining that the operation to delete a displayable information item is performed in this process (e.g., Yes in Step S207), the control unit 205 deletes the displayable information item (Step S208). The displayable information deletion includes Steps S300 to S306 shown in FIG. 17, and will be described below.

On the other hand, when no list screen is being displayed in Step S204 (e.g., No in Step S204), the control unit 205 determines whether a displayable information item is being displayed on the display unit 200 (Step S209). In response to determining that a displayable information item is being displayed in this process (e.g., Yes in Step S209), the control unit 205 moves the process to Step S210.

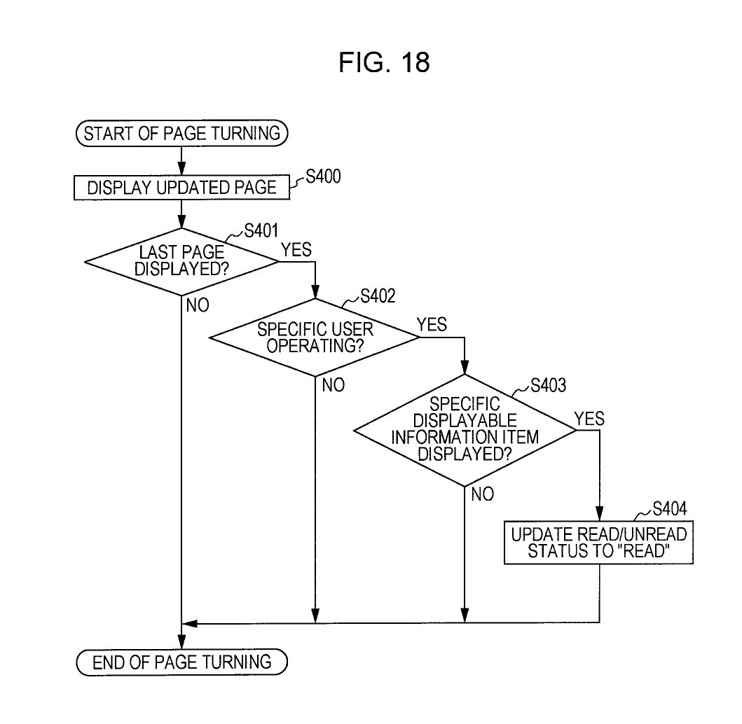

In Step S210, the control unit 205 determines whether an operation to turn a page is performed. This determination may be made, in one or more arrangements, based on whether the LEFT or RIGHT button of the input unit 202 is pushed down or otherwise selected. In response to determining that the operation to turn a page is performed in this process (e.g., Yes in Step S210), the control unit 205 turns a page (Step S211). The page turning includes Steps S400 to S404 shown in FIG. 18, and will be described below.

The control unit 205 ends the key-input standby process after the processes in Steps S203, S206, S208, and S211, when the operation to delete a displayable information item is not performed in Step S207 (e.g., No in Step S207), when a displayable information item is not being displayed in Step S209 (e.g., No in Step S209), or when the operation to turn a page is not performed in Step S210 (e.g., No in Step S210).

Next, an example displayable information deletion process in Step S208 will be described in detail with reference to FIG. 17.

As shown in FIG. 17, when the displayable information deletion process starts, the control unit 205 determines whether or not the read/unread status corresponding to the displayable information item currently displayed on the display unit 200 is “read” (Step S300). When it is determined that the read/unread status is “read” in this process (e.g., Yes in Step S300), the control unit 205 moves the process to Step S303.

On the other hand, when the read/unread status is not “read” in Step S300 (e.g., No in Step S300), the control unit 205 displays a warning that the displayable information item the user is about to delete is unread on the display unit 200 as shown in FIG. 11 (Step S301).

Next, the control unit 205 determines whether or not an instruction to delete the displayable information item has been issued (Step S302). For example, the determination may be made based on whether a field, displayed on the display unit 200, for accepting the deletion of the displayable information item has been selected in accordance with inputs such as LEFT, RIGHT, and ENTER buttons of the input unit 202. Upon determining that the instruction to delete the displayable information item has been issued in this process (e.g., Yes in Step S302), the control unit 205 moves the process to Step S303.

In Step S303, the control unit 205 deletes the displayable information item displayed on the display unit 200 from the storage unit 201 or the memory card 3.

As described above, a warning that the displayable information item is unread is displayed when the displayable information item is about to be deleted without the displayable information item's read/unread status having been updated to “read” according to this embodiment. This can prevent users from accidentally deleting unread displayable information items.

Next, the control unit 205 acquires the displayable information, the read/unread status information corresponding to the displayable information, and the like stored in the storage unit 201 or the memory card 3 (Step S304), generates a list screen on the basis of the acquired information (Step S305), and displays the generated list screen on the display unit 200 (Step S306).

The control unit 205 ends the displayable information deletion after the process in Step S306 or when the instruction to delete (or a confirmation of the instruction to delete) the displayable information item is not issued in Step S302 (e.g., No in Step S302).

Next, the page turning process in Step S211 will be described in detail with reference to FIG. 18.

As shown in FIG. 18, the control unit 205 displays an updated page when the page turning process starts (Step S400). That is, the control unit displays the next page when the RIGHT button of the input unit 202 is pushed down while a displayable information item is being displayed, and displays the previous page when the LEFT button is pushed down.

Next, the control unit 205 determines whether or not the last page of the displayable information item has been displayed (Step S401). When it is determined that the last page of the displayable information item has been displayed in this process (e.g., Yes in Step S401), the control unit 205 moves the process to Step S402.

In Step S402, the control unit 205 determines whether the user is a specific user. For example, the control unit 205 may determine whether the user is a specific user by determining whether the user ID of the user authenticated in the user authentication process of Step S100 shown in FIG. 15 corresponds to the user ID of the specific user determined in the specific-user determination process in Step S102. In response to determining that the user is the specific user in this process (e.g., Yes in Step S402), the control unit 205 moves the process to Step S403.

In Step S403, the control unit 205 determines whether the displayable information item displayed on the display unit 200 is a specific displayable information item. In one arrangement, the determination is made based on whether the terminal ID associated with the currently displayed displayable information item corresponds to the terminal ID of the display apparatus stored in the storage unit 201. In response to determining that the displayable information item is the specific displayable information item in this process (e.g., Yes in Step S403), the control unit 205 updates the read/unread status corresponding to the currently displayed displayable information item to “read” (Step S404).

The control unit 205 may end the page turning process upon completion of Step S404, when the last page of the displayable information item is not displayed in Step S401 (e.g., No in Step S401), when the user is not a specific user in Step S402 (e.g., No in Step S402), or when the displayable information item is not a specific displayable information item in Step S403 (e.g., No in Step S403).

Although some embodiments of the present invention have been described in detail above while referring to the drawings, the embodiments are intended as examples only, and various modifications and improvements are possible on the basis of knowledge of those skilled in the art.

For example, the read/unread status information corresponds to information indicating whether the displayable information has been read or is unread in the displayable-information management system S according to one or more arrangements. However, the read/unread status information can include information related to other types of reading statuses such as “all pages read”, “read up to page X”, and “read for X minutes” in addition to the read/unread status information.

Moreover, the displayable information, the read/unread status information, and the like are transferred between the displayable-information management apparatus 1 and the display apparatuses 2 via the memory card 3 in the displayable-information management system S according to this embodiment. However, the present invention is not limited to this, and the information can be transferred via wired or wireless communication. For example, the information may be transferred by using the communication interface 104 of the displayable-information management apparatus 1 and the communication interfaces 204 of the display apparatuses 2.

In the displayable-information management system S according to this embodiment, the displayable-information management apparatus 1 that receives the read/unread status information updated to “read” from the display apparatuses 2 updates the read/unread status information to “read” using the read/unread status information update unit when the display apparatuses 2 transfer the read/unread status information updated to “read” to the displayable-information management apparatus 1 using the read/unread status information transfer units.

Although the displayable-information management system S according to this embodiment includes the displayable-information management apparatus 1 and the plurality of display apparatuses 2, the present invention is not limited to this, and the system can include only the plurality of display apparatuses 2.

In this case, the display apparatuses each include a storage unit that stores the displayable information associated with the read/unread status information indicating whether or not the displayable information has been read, a display unit that displays the displayable information, an information exchange unit that exchanges the displayable information and the read/unread status information with other apparatuses, and a read/unread determination unit that determines whether or not the displayable information has been read, and a read/unread status information update unit that updates the read/unread status information corresponding to the displayable information from “unread” to “read” when the read/unread determination unit determines that the displayable information has been read, and the read/unread status information of the displayable information has been updated from “unread” to “read” only when the read/unread determination units determine that the displayable information has been read in specific display apparatuses.

Specific display apparatuses herein may include display apparatuses having terminal IDs identical to those associated with the displayable information, display apparatuses set as specific display apparatuses on the basis of the terminal IDs by the display apparatuses retaining the displayable information, or display apparatuses set in the first mode.

As described above, the displayable-information management system includes a plurality of display apparatuses each including a storage unit that stores displayable information associated with read/unread status information indicating read/unread statuses, a display unit that displays the displayable information, an information exchange unit that exchanges the displayable information and the read/unread status information with other apparatuses, a read/unread determination unit that determines whether or not the displayable information has been read, and a read/unread status information update unit that updates the read/unread status information corresponding to the displayable information when the read/unread determination unit determines that the displayable information has been read. The system manages the read/unread status of the displayable information when the displayable information retained in one of the display apparatuses is read on the display apparatus or the other apparatuses, and the read/unread status information update unit updates the read/unread status information of the displayable information only when the read/unread determination unit determines that the displayable information has been read on a specific display apparatus. With this, the information whether or not the displayable information has been read can be managed in an integrated manner.

The user authentication unit in the displayable-information management system S according to this embodiment uses so-called password authentication. However, authentication methods using biometrics (for example, finger vein authentication, fingerprint authentication, handprint authentication, retina authentication, iris authentication, face authentication, blood vessel authentication, signature authentication, typing habit authentication, and voice/voiceprint authentication) can also be used for user authentication.

What is claimed is:

1. An apparatus comprising:
at least one processor; and
at least one memory operatively coupled to the at least one processor and storing computer readable instructions that, when executed, cause the apparatus to:
receive a displayable information item and a read/unread status of the displayable information item from a displayable information management device;
store the displayable information item and the read/unread status;
determine whether the displayable information item has been read on the apparatus;
in response to determining that the displayable information item has been read on the apparatus, updating the read/unread status of the displayable information item; and
transmit the updated read/unread status of the displayable information item to the displayable information management device.

2. The apparatus of claim 1, wherein the computer readable instructions, when executed, further cause the apparatus to:
select a determination mode from between a first mode in which the read/unread status of the displayable information item is to be determined by the apparatus and a second mode in which the read/unread status of the displayable information item is not to be determined by the apparatus.

3. The apparatus of claim 1, wherein determining whether the displayable information item has been read includes determining whether the displayable information item corresponds to a predefined displayable information item.

4. The apparatus of claim 3, further comprising:
an ID storage unit storing a unique ID of the apparatus,
wherein the displayable information item is determined to have been read only upon determining that displayable information is associated with an apparatus ID corresponding to the unique ID of the apparatus.

5. The apparatus of claim 1, wherein the computer readable instructions, when executed, further cause the apparatus to:
authenticate a user of the apparatus, and
determine whether the authenticated user corresponds to a predefined user, wherein the displayable information item is only determined to have been read upon determining that the authenticated user corresponds to the predefined user.

6. The apparatus of claim 1, wherein determining that the displayable information item has been read includes determining that a first page of the displayable information item has been displayed by the apparatus, wherein the displayable information item includes a plurality of pages.

7. The apparatus of claim 1, wherein determining that the displayable information item has been read includes determining that the displayable information item includes a plurality of pages and a last page of the displayable information item has been displayed by the second display unit.

8. The apparatus of claim 1, wherein determining that the displayable information item has been read includes determining that the displayable information includes a plurality of pages and all pages of the displayable information item have been displayed by the second display unit.

9. The apparatus of claim 1, wherein the read/unread status is associated with the displayable information item by allocating character information indicating whether the displayable information item has been read or is unread as a file name of the displayable information.

10. The apparatus of claim 1, wherein the read/unread status includes date information indicating when the displayable information item was read first, last, or first and last on the apparatus.

11. The apparatus of claim 1, wherein the apparatus includes a mobile terminal having an electrophoretic display panel.

12. The apparatus of claim 1, wherein the computer readable instructions, when executed, further cause the apparatus to display a warning that the displayable information is unread on a display of the apparatus upon determining that the displayable information item stored in the storage unit of the apparatus is about to be deleted without the read/unread status corresponding to the displayable information having been updated to a read status.

13. A displayable-information management system comprising:
a plurality of display apparatuses, each including:
a storage unit that stores displayable information items associated with read/unread status information indicating a read/unread status of the displayable information items,
a display unit that displays a displayable information item,
an information exchange unit that transmits and receives the displayable information item and the read/unread status of the displayable information item to and from other apparatuses,
wherein each of the plurality of display apparatuses are configured to:
determine whether the displayable information item has been read, and
update the read/unread status corresponding to the displayable information item only upon determining that the displayable information item has been read on a specific display apparatus
wherein the system manages the read/unread status of the displayable information items when the displayable information items are read on one or more of the plurality of display apparatuses.

14. The displayable-information management system of claim 13, wherein the system further comprises a displayable information management device separate from the plurality of display apparatuses, wherein the system manages the read/unread status of the displayable information items using the displayable information management device.

15. The displayable-information management system of claim 14, wherein the displayable information management device is configured to convert the displayable information item from a first format to a second format prior to transmitting the displayable information item to one or more of the display apparatuses.

16. An apparatus comprising:
at least one processor; and
at least one memory operatively coupled to the at least one processor and storing computer readable instructions that, when executed, cause the apparatus to:
store a displayable information item and read/unread status information indicating a read/unread status of the displayable information item at the apparatus,
provide the displayable information item and the read/unread status information to a storage device different from the apparatus;
receive read/unread status information from a display apparatus;
determine whether the read/unread status information indicates that the read/unread status of the displayable information item has been updated; and
update the read/unread status of the displayable information item upon determining that the read/unread status information indicates that the read/unread status of the displayable information item has been updated.

17. The apparatus of claim 16, further comprising computer readable instructions that, when executed, cause the apparatus to:
convert the displayable information item from a first format to a second format prior to providing the displayable information item to the storage device, wherein the display apparatus is incompatible with the first format and compatible with the second format.

18. The apparatus of claim 16, further comprising computer readable instructions that, when executed, cause the apparatus to display displayable information items in a first appearance when the displayable information items have an unread status and in a second appearance when the displayable information items have a read status.

19. One or more non-transitory computer readable media storing computer readable instructions that, when executed, cause an apparatus to:
receive a displayable information item and a read/unread status of the displayable information item from a displayable information management device;
store the displayable information item and the read/unread status;
determine whether the displayable information item has been read on the apparatus;
in response to determining that the displayable information item has been read on the apparatus, updating the read/unread status of the displayable information item; and
transmit the updated read/unread status of the displayable information item to the displayable information management device.

20. One or more non-transitory computer readable media storing computer readable instructions that, when executed, cause an apparatus to:
store a displayable information item and read/unread status information indicating a read/unread status of the displayable information item at the apparatus,
provide the displayable information item and the read/unread status information to a storage device different from the apparatus;
receive read/unread status information from a display apparatus;
determine whether the read/unread status information indicates that the read/unread status of the displayable information item has been updated; and
update the read/unread status of the displayable information item upon determining that the read/unread status information indicates that the read/unread status of the displayable information item has been updated.

21. A method comprising:
receiving, by a display apparatus, a displayable information item and a read/unread status of the displayable information item from a displayable information management device different from the display apparatus;
storing, by the display apparatus, the displayable information item and the read/unread status;
determining, by the display apparatus, whether the displayable information item has been read on the apparatus;
in response to determining that the displayable information item has been read on the display apparatus, updating, by the display apparatus, the read/unread status of the displayable information item; and
transmitting, by the display apparatus, the updated read/unread status of the displayable information item to the displayable information management device.

22. A method comprising:
storing, by a displayable information management device, a displayable information item and read/unread status information indicating a read/unread status of the displayable information item,
providing, by the displayable information management device, the displayable information item and the read/unread status information to a storage device different from the displayable information management device;
receiving, by the displayable information management device, read/unread status information from a display apparatus different from the displayable information management device;
determining, by the displayable information management device, whether the read/unread status information indicates that the read/unread status of the displayable information item has been updated; and
updating, by the displayable information management device, the read/unread status of the displayable information item upon determining that the read/unread status information indicates that the read/unread status of the displayable information item has been updated.

23. The method of claim 22, wherein the display apparatus includes the storage device.
